(19) United States
(12) Patent Application Publication
(10) Pub. No.: US 2009/0223900 A1
(43) Pub. Date: Sep. 10, 2009

(54) WASTEWATER TREATMENT APPARATUS AND METHOD

(75) Inventor: Paul E. Adler, Macon, GA (US)

Correspondence Address: ELEY LAW FIRM CO., 7870 OLENTANGY RIVER RD, SUITE 311, COLUMBUS, OH, 43235, US

(73) Assignee: MINERAL ASSETS, LLC, MACON, GA (US)

(21) Appl. No.: 12/396,991

(22) Filed: Mar. 3, 2009

Related U.S. Application Data
(60) Provisional application No. 61/068,080, filed on Mar. 4, 2008.

(51) Int. Cl. C02F 1/02; C02F 103/00

(52) U.S. Cl. 210/741; 210/137; 210/103

(57) ABSTRACT

Bacterial contamination is removed from wastewater by a sterilizing process and apparatus (10). A wastewater piping circuit (26, 28, 30, 31, 32, 34) interconnects a supply tank (12), three serial heat exchangers (16, 18, 20), and a storage tank (14). The circuit and storage tank are sanitized by flushing with a mist of hydrogen peroxide (44) and nitrogen (50). One heat exchanger (16) transfers heat from the sterilized wastewater to the unsterilized wastewater. A closed hot process water piping circuit (60, 62, 64) interconnects a hot process water boiler (22) and the other two heat exchangers (18, 20). The wastewater is sterilized in an insulated holding tank (24) interconnecting the other two heat exchangers (18, 20). Wastewater is pumped through the piping and heated by hot process water in the manifold to kill the bacteria, and is covered by a layer of nitrogen (54) in the storage tank (14).

This application claims priority to U.S. provisional application 61/068,080, filed Mar. 4, 2008, the contents of which are hereby incorporated by reference.

### FIELD

This invention relates generally to treating contaminated liquids and, more particularly, to a biologically-contaminated wastewater sterilization process and apparatus.

### BACKGROUND

Industry and sanitation facilities use millions of gallons of potable water each day. In use, this water is contaminated and cannot be further used without decontaminating the water. For example, a contamination problem exists with regard to water used in paper mills. Water is used in great quantities in the manufacture and processing of paper. This processing water becomes bacteria-contaminated and must be decontaminated for reuse, usually via use of chemical treatments.

In general, the treatment of bacterially-contaminated water or wastewater is a problem world-wide, both as regards treating industrial and sanitation wastewater for return to the habitat and the provision of adequate quantities of drinking water for human consumption. Several methods are currently used to treat contaminated wastewater. These include distillation, chemical treatment, reverse osmosis, and ultraviolet treatment. Each of these methods has its shortcomings, such as capacity and expense.

There is a need for apparatus and a process for decontaminating bacterially-contaminated wastewater and for providing a process and apparatus for producing safe drinking water from bacterially-contaminated water.

### SUMMARY

It is therefore an object of this invention to provide apparatus and a process for eliminating bacterial contamination of process water that eliminates the necessity for repeated treatment by chemicals.

It is also an object to provide a need for apparatus and a process for decontaminating bacterially-contaminated waste water and for providing a process and apparatus for producing safe drinking water from bacterially-contaminated water.

As used in this application, the term “contaminated wastewater” shall mean water contaminated by aerobic and anaerobic bacteria. The terms “potable water” and “safe drinking water” are used interchangeably.

According to a preferred embodiment of this invention, apparatus is provided for decontaminating contaminated wastewater by sterilizing it. A piping circuit interconnects a supply tank, three heat exchangers, a holding tank, and a storage tank. The circuit and storage tank are sanitized by flushing with hydrogen peroxide. One heat exchanger transfers heat from the sterilized water to the unsterilized water. A closed hot water piping circuit interconnects a hot water boiler, the holding tank and two other heat exchangers. The piping interconnecting the holding tank and two heat exchangers is an insulated manifold where contaminated wastewater is sterilized by the heat from circulating process water from the boiler via the closed hot water piping circuit. Wastewater is pumped through the piping and heated by process hot water in the holding tank to kill the bacteria in the wastewater, and is stored and may be covered by a layer of nitrogen for use immediately or eventually. The eventual use can be as processing water in a paper mill or for drinking or for return to the habitat or other uses requiring decontaminated water.

In one aspect, this invention features a process for sterilizing contaminated wastewater, which comprises the steps of providing a sanitized fluid handling system, pumping the contaminated wastewater through the system at a predetermined flow rate, heating the contaminated wastewater to a sterilizing temperature of about 210° F. for a predetermined time to sterilize the wastewater, cooling the sterilized wastewater to a temperature below 100° F., and transferring the sterilized wastewater to a fluid collection tank, which may be a stationary or transportable storage tank or the supply system for a further use, such as for potable or drinking water.

In another aspect of this invention, the process includes the optional further step of excluding oxygen from the collection tank by covering the sterilized wastewater with a blanket of nitrogen.

In yet another aspect, this invention features fluid handling and sterilizing apparatus for sterilizing contaminated wastewater, which includes a supply tank for holding the contaminated wastewater, and a sterilizing unit for heating the contaminated wastewater to a sterilizing temperature. A heat exchanger transfers heat from the sterilized wastewater to the contaminated wastewater, thus preheating the contaminated wastewater and cooling the sterilized wastewater. A wastewater piping circuit connects the supply tank to the heat exchanger and connects the heat exchanger to the sterilizing unit for handling the contaminated wastewater, and connects the sterilizing unit to the heat exchanger and exits the heat exchanger for handling the sterilized wastewater. A pump pumps process water through the piping circuit at a predetermined pressure in order to maintain all wastewater in a liquid state, regardless of temperature.

In a further aspect of this invention, the sterilizing unit includes a heating unit, a second heat exchanger for transferring heat from the heating unit to the contaminated wastewater to raise the temperature of the contaminated wastewater to a sterilizing temperature, a holding tank for maintaining the heated wastewater at the sterilizing temperature, and a third heat exchanger for transferring heat from the sterilized wastewater to the heating unit to cool the sterilized wastewater.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a schematic representation of the apparatus and process according to this invention;

FIG. 2 is a simplified version of the schematic of FIG. 1, depicting system temperatures measured during successful operation of a sterilizing system according to this invention;

FIG. 3 is a plan view of the system of FIG. 1, shown mounted on a semi-trailer; and

FIG. 4 is a side view of the system of FIG. 1, shown mounted on a semi-trailer.

### DETAILED DESCRIPTION

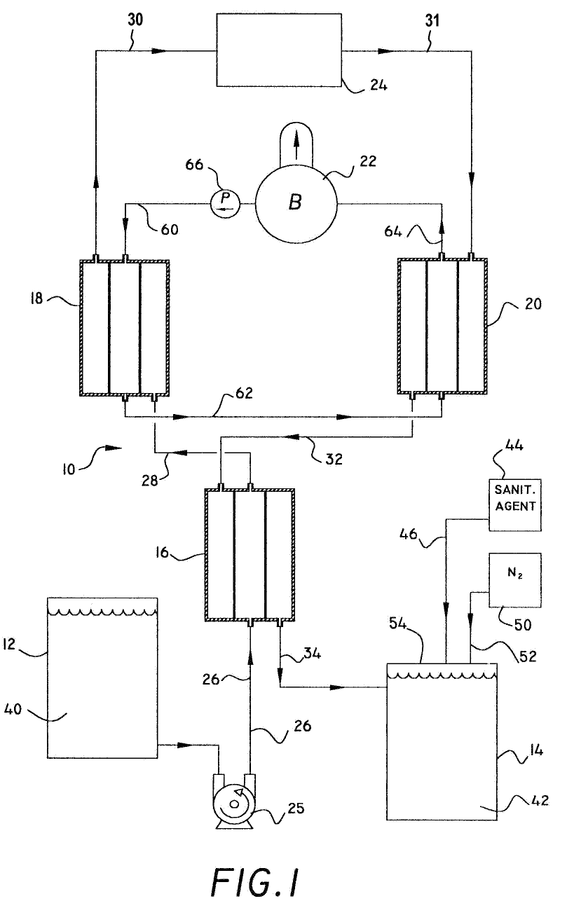

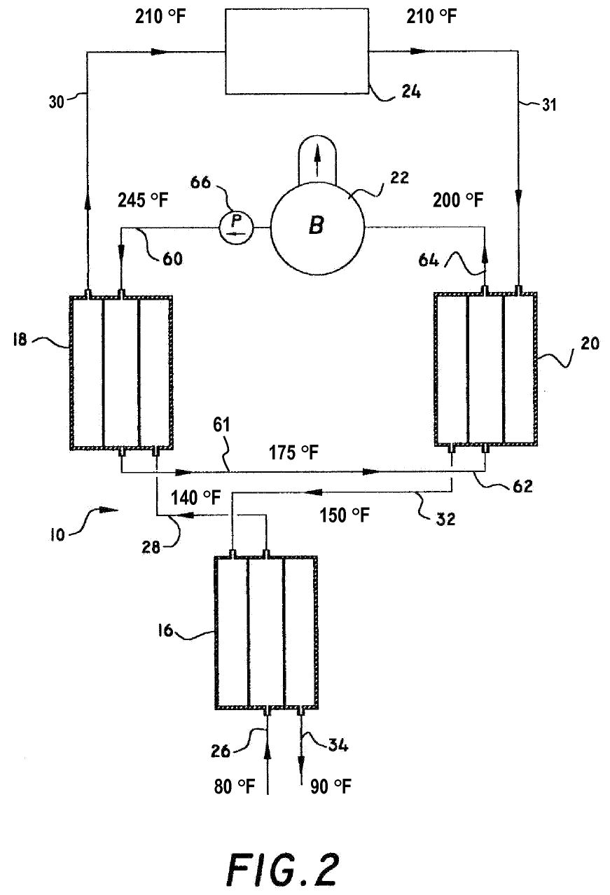

FIGS. 1 and 2 of the drawings schematically depict the major components of a system 10 for continuously sterilizing contaminated wastewater according to a preferred embodiment of this invention. These comprise a supply tank 12, a storage tank 14, serially arranged heat exchangers 16, 18 and 20, a hot water boiler 22 for heating process water, and a holding tank 24, which may be insulated.

A pump 25 at supply tank 12 pumps wastewater through a piping system, which includes a supply pipe 26 from pump 25 to heat exchanger 16, a connecting pipe 28 that connects heat exchangers 16 and 18, wastewater manifold piping 30, 31 that connects heat exchangers 18 and 20 via holding tank 24, a connecting pipe 32 that connects heat exchangers 20 and 16, and an outlet pipe 34 that exits heat exchanger 16 and enters storage tank 14. The direction of wastewater flow is indicated by arrows in FIGS. 1 and 2. Pipe 34 may alternatively connect directly into the intake of a system for further use, such as a water supply system (not shown) rather than connecting to storage tank 14. Tanks 12 and 14 may be stationary, or mobile, such as mounted on a rail car, semi-trailer, or ship. Indeed, the wastewater sterilizing system 10 itself may be stationary or may be mounted on a similar mobile platform for transportation to a variety of locations for on-site processing and use.

With continued reference to FIGS. 1 and 22, at the initiation of the process of this invention supply tank 12 may be filled with bacterially-contaminated wastewater 40, while storage tank 14 will normally be empty. This process is a continuous process, so that eventually tank 14 will fill with sterilized wastewater 42. Prior to initiation of this process, at least tank 14, and pipes 34, 32, 31 and 30, and preferably pipes 28 and 26 may be sanitized by backflushing with a sanitizing agent, such as hydrogen peroxide, supplied from a supply 44 via a delivery nozzle 46. Oxygen is purged from the system 10 by the simultaneous introduction of nitrogen from a supply 50 via a nozzle 52.

The heating unit for the sterilizing apparatus 10 includes hot process water boiler 22, and a second or hot process water piping system, that includes an outlet pipe 60 from boiler 22 to heat exchanger 18, a connecting pipe 62 connecting heat exchangers 18 and 20, and an inlet pipe 64 connecting heat exchanger 20 to boiler 22. A pump 66 pumps water through the closed hot process water system at a predetermined pressure in the direction indicated by arrows in the drawings. The pressure of the hot process water system should be sufficient to preclude formation of steam. The heating unit, holding tank 24 and heat exchangers 18 and 20 comprise the sterilizing unit.

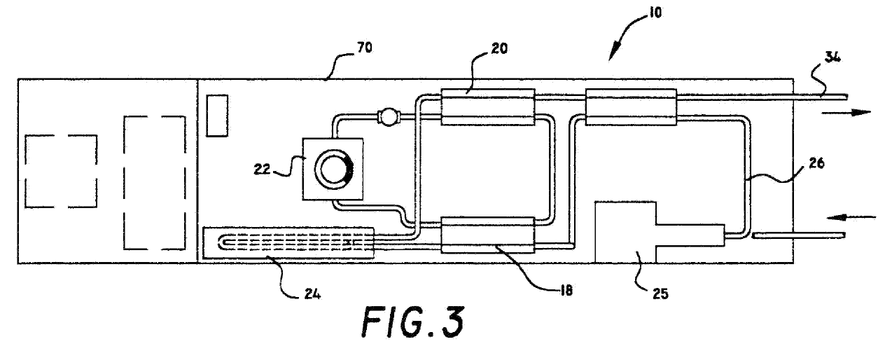

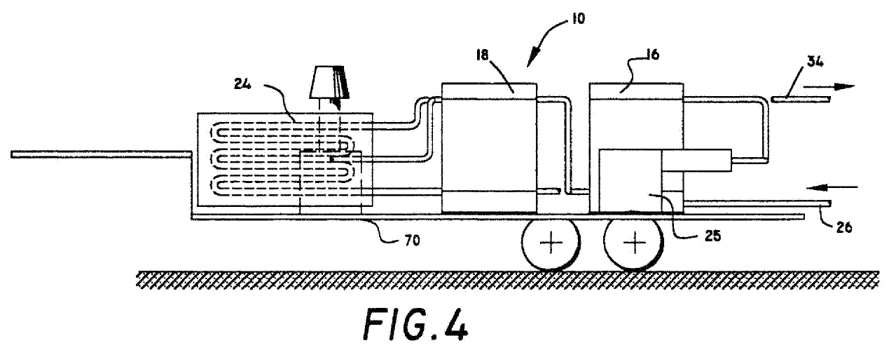

A sterilization system, illustrated in FIGS. 3 and 4, is mounted on a semi-trailer 70. This system utilizes a manifold comprising about 60 feet of 4-inch stainless steel wastewater pipe and an array of 2-inch stainless steel hot water pipe—all enclosed in a stainless steel box containing 3-inch rock wool insulation. The heating system utilizes a 300,000 British Thermal Unit per hour (“BTU/hr”) propane-fired boiler and a pumping system that pumps hot process water at about 30 gallons per minute (“gpm”). A wastewater pump pumps wastewater through the system at about 17 gpm. Three substantially identical plate heat exchangers 16, 18, 20 supplied by, for example, Aluminum Plant & Vessel Company Ltd. (APV”), are interconnected by insulated piping runs of about 10 feet. A generator set (not shown) may be used to provide electrical power for system 10.

In an example process, a target sterilizing temperature is set at about 210° F. and a holding time of up to about 2 minutes in the sterilizing holding tank 24. Treatment time is dependent on the volume of the piping used and treatment temperature. A preferred temperature range is about 200° F.-210° F. The temperature of the cooled sterilized wastewater is about 90° F. at pipe 34, and a temperature below about 100° F. is preferred to facilitate handling.

The system 10 is fogged with a mist composed of a mixture of nitrogen and hydrogen peroxide emitted from tanks 44, 50 through a dual nozzle to sanitize the system. After the system is activated and brought to temperature, wastewater is pumped through the sanitized system. Temperatures in all segments of the system are monitored, as is water flow. Example temperatures are depicted in FIG. 2. Samples are taken of sterilized wastewater to confirm that sterilization is complete. The present invention makes it possible to sterilize contaminated wastewater without using bactericides or other chemicals.

This process is quite economical, as the heating unit recovers about 98% of the boiler 22 heat. Thus, only about 2% boiler makeup is necessary. This economy results from the use of heat exchangers to transfer heat. As FIG. 2 shows, the incoming about 80° F. contaminated wastewater (at pipe 26) is pre-heated to about 140° F. in heat exchanger 16 by about 150° F. sterilized wastewater (pipe 32), the wastewater cooling to an exit temperature of about 90° F. at pipe 34. The pre-heated contaminated wastewater is elevated to a sterilizing temperature in heat exchanger 18 by about 245° F. hot process water from boiler 22 (via pipe 60) to a temperature of about 210° F., as measured in pipe 30 and in holding tank 24, which receives the wastewater from heat exchanger 18. Hot process water exits heat exchanger 18 at about 175° F. via a pipe 61 and is coupled to an input of heat exchanger 20. Sterilized wastewater, which exits holding tank 24 via pipe 31 at about 210° F., reheats the hot process water from heat exchanger 18 to about 200° F. in heat exchanger 20, the sterilized wastewater exiting heat exchanger 20 via pipe 32 at about 150° F. Thus, boiler 22 is supplied with about 200° F. intake process water, which it needs to elevate in temperature only about 45° F.

With continued reference to FIG. 2, in operation bacterial contamination is removed from wastewater by a sterilizing process and apparatus 10. A wastewater piping circuit 26, 28, 30, 31, 32, 34 interconnects a supply tank 12, three serial heat exchangers 16, 18, 20, and a storage tank 14. The circuit and storage tank are sanitized by flushing with a mist of hydrogen peroxide 44 and nitrogen 50. One heat exchanger 16 transfers heat from the sterilized wastewater to the unsterilized wastewater. A closed hot process water piping circuit 60, 62, 64 interconnects a hot process water boiler 22 and the other two heat exchangers 18, 20. The wastewater is sterilized in an insulated holding tank 24 interconnecting the other two heat exchangers 18, 20. Wastewater is pumped through the piping and heated by hot process water in the manifold to kill the bacteria, and is covered by a layer of nitrogen 54 in the storage tank 14.

Preferably, a mist or fog of nitrogen and hydrogen peroxide is used to sanitize the system 10. Sanitizing chemicals other than hydrogen peroxide may also be used to kill any bacteria in the system. As wastewater from supply 40 transits wastewater piping 26, 28, 30, 31, 32 and 34 into storage tank 14, this fog is forced into storage tank 14, where the condensed hydrogen peroxide will be drained and the nitrogen will blanket wastewater 42 to exclude contact with oxygen.

The nitrogen blanket may be maintained during any subsequent shipping of tank 14 to a distant terminus by truck, rail or ship. Depending on the degree of sterilization maintained (a function of time and equipment), the transported wastewater may again undergo the same sterilization process by another or similar installation of sterilizing equipment 10.

While only a preferred embodiment has been illustrated and described, obvious modifications are contemplated within the scope of this invention, as defined by the appended claims. For example, other types of heating systems could be used to sterilize the wastewater, although systems using a liquid are preferred because of their efficiency. As another example, solar heating panels may be used in place of boiler 22 or in combination therewith, within the scope of the invention.

What is claimed is:

1. A process for sterilizing contaminated wastewater, comprising the steps of:
a. providing a sanitized fluid handling system;
b. pumping the wastewater through the system at a predetermined pressure;
c. heating the wastewater to a sterilizing temperature for a predetermined time to sterilize the wastewater;
d. cooling the wastewater; and
e. transferring the sterilized wastewater to a sanitized fluid collection device.

2. The process of claim 1, further comprising the step of flushing the fluid handling system with a mist of nitrogen and a sanitizing chemical to sanitize the system.

3. The process of claim 1 wherein the sterilizing temperature is about 200° F.-210° F., the predetermined time is greater than 5 seconds, and the cooling temperature is below about 100° F.

4. The process of claim 3 wherein the sterilizing temperature is about 210° F. and the predetermined time is about 2 minutes.

5. The process of claim 1 wherein the sanitized fluid collection device is a storage tank, and further including the steps of:
f. flushing the fluid handling system with a mist of nitrogen and a sanitizing chemical to sanitize the system; and
g. excluding oxygen from the storage tank.

6. The process of claim 1, further comprising the steps of:
f. flushing the fluid handling system with a mist of nitrogen and a hydrogen peroxide to sanitize the system; and
g. excluding oxygen from the tank by covering the sterilized wastewater with a blanket of nitrogen.

7. The process of claim 1 wherein the fluid collection device is the supply system for supplying processing water in a further industrial process in a paper mill.

8. The process of claim 1, further comprising the step of mounting the fluid handling system on a mobile platform for transportability.

9. A fluid handling and sterilizing apparatus for sterilizing contaminated wastewater, comprising:
a sterilizing unit for heating contaminated wastewater to a sterilizing temperature;
a heat exchanger for transferring heat from the sterilized wastewater to the unsterilized wastewater to preheat the unsterilized wastewater and cool the sterilized wastewater;
a piping circuit connecting the pump to the heat exchanger and connecting the heat exchanger to the sterilizing unit for handling the unsterilized wastewater, and connecting the sterilizing unit to the heat exchanger and exiting the heat exchanger for handling the sterilized wastewater; and
a pump for intaking unsterilized wastewater and pumping wastewater through the piping circuit at a first predetermined flow rate.

10. The fluid handling and sterilizing apparatus of claim 9, wherein the sterilizing unit further comprises:
a heating unit;
a second heat exchanger for transferring heat from the heating unit to the unsterilized wastewater to raise the temperature of the unsterilized wastewater to a sterilizing temperature;
a manifold for containing the heated wastewater at the sterilizing temperature; and
a third heat exchanger for transferring heat from the sterilized wastewater to the heating unit to cool the sterilized wastewater.

11. The fluid handling and sterilizing apparatus of claim 10 wherein the manifold is sized to maintain the wastewater at the sterilizing temperature for a predetermined time sufficient to fully sterilize the wastewater.

12. The fluid handling and sterilizing apparatus of claim 10 wherein the heating unit further comprises:
a hot water boiler for heating processing water to a second predetermined temperature;
a second piping circuit interconnecting the hot processing water boiler, the second heat exchanger, and the third heat exchanger; and
a second pump for pumping processing water through the second piping circuit at a second predetermined flow rate.

13. The fluid handling and sterilizing apparatus of claim 12 wherein the first predetermined flow rate is about 17 gallons per minute and the second predetermined flow rate is about 30 gallons per minute.

14. The fluid handling and sterilizing apparatus of claim 11, further comprising a mobile platform mounting the apparatus to enable transportation to a variety of locations.
